(19) United States
(12) Patent Application Publication
(10) Pub. No.: US 2026/0320825 A1
(43) Pub. Date: Oct. 15, 2026

(54) METHODS AND SYSTEMS FOR ILLUMINATION ANGLE CALIBRATION

(71) Applicant: CSR BIOTECH (GUANGZHOU) CO., LTD., Guangzhou (CN)

(72) Inventors: Lintao LIANG, Guangzhou (CN); Haojun ZHANG, Guangzhou (CN); Haiwen LI, Guangzhou (CN)

(73) Assignee: CSR BIOTECH (GUANGZHOU) CO., LTD., Guangzhou (CN)

(21) Appl. No.: 19/681,164

(22) Filed: May 19, 2026

Related U.S. Application Data
(63) Continuation of application No. PCT/CN2024/099391, filed on Jun. 14, 2024.

(30) Foreign Application Priority Data
Dec. 4, 2023 (CN) 202311641750.2

(51) Int. Cl. G06T 7/73; G02B 21/06; G02B 21/36; G06T 7/80

(52) U.S. Cl. CPC G06T 7/74; G02B 21/365; G06T 7/80; G02B 21/06; G06T 2207/10056

(57) ABSTRACT

A method for calibrating an illumination angle of a microscope includes obtaining one or more initial images by imaging a calibration device using the microscope (510); and determining illumination angle data of the microscope based on the one or more initial images (520).

### CROSS-REFERENCE TO RELATED APPLICATIONS

This application is a Continuation of International Application No. PCT/CN2024/099391, filed on Jun. 14, 2024, which claims priority of Chinese Patent Application No. 202311641750.2, filed on Dec. 4, 2023, the entire contents of each of which are hereby incorporated by reference.

### TECHNICAL FIELD

The present disclosure relates to the field of imaging technology, and in particular, to methods and systems for calibrating an illumination angle of a microscope.

### BACKGROUND

Micro-optical imaging is a primary approach for obtaining information across scales in biological systems, and plays an important role in structural and functional studies at various levels (e.g., from molecule, cell, or tissue to organ). Fluorescent labeling imaging has strict requirements on the object(s) to be imaged, and has a limited count of fluorescent labeling channels. Besides, the presence of photobleaching of fluorescent groups and/or phototoxicity to the imaged object(s) affects the application of fluorescent labeling imaging. In comparison with fluorescent labeling imaging, the micro-optical imaging provides label-free imaging that ensures that the life activities of the object(s) are not affected by the imaging process, and is therefore widely used in the fields of digital pathology, cancer therapy, regenerative medicine, and personalized medicine. With the development of computational imaging technology, a variety of label-free imaging techniques which is realized based on optical field propagation model(s) have emerged in recent years, such as Fourier Ptychography Microscope (FPM), Optical Diffractive Tomographic Microscopy (ODT), or the like. In these imaging methods, the imaging system detects different frequency domain components of the object(s) under the modulation of plane wave illumination in different directions. By constructing a propagation model of an interaction between the object(s) and the light field, a reconstruction algorithm can demodulate the physical features of the object(s) that are undetectable by conventional microscopes, such as a refractive index distribution and absorption coefficients. However, the reconstruction performed based on plane-wave illumination modulation in practical application relies on an accurate imaging model, in which an illumination angle directly corresponds to a spatial position of a frequency domain component of the object(s), and consequently, an error of the illumination angle may lead to reconstruction artifact(s).

Therefore, it is desirable to provide methods and systems for calibrating illumination angle(s) of microscope(s) effectively and accurately.

### SUMMARY

According to one embodiment of the present disclosure, a method for calibrating an illumination angle of a microscope is provided. The method for calibrating an illumination angle of a microscope may include: obtaining an initial image by imaging a calibration device using the microscope; and determining illumination angle data of the microscope based on the initial image.

According to one embodiment of the present disclosure, a method for calibrating an illumination angle of a microscope is provided. The method may include: placing an objective lens of the microscope in a first working position; starting at least one light source of an illumination device of the microscope to emit light one by one, when any light source of the at least one light source is started to emit the light, imaging a projection of the light that is emitted by the any light source and passes through a phantom on the auxiliary imaging element, and obtaining the projection image corresponding to the any light source; placing the objective lens at a second working position; obtaining a reference image by imaging the phantom using the microscope; and determining the illumination angle data of the microscope based on the reference image and at least one projection image corresponding to the at least one light source.

According to one embodiment of the present disclosure, a system for calibrating an illumination angle of a microscope is provided. The system may include: a phantom including a plurality of light-transmissive holes, the phantom is configured to obtain the reference image by imaging the plurality of light-transmissive holes using the microscope; an auxiliary imaging element configured to obtain the at least one projection image corresponding to the at least one light source of the illumination device of the microscope, where the at least one projection image is obtained by: starting the at least one light source of the illumination device to emit the light one by one, when the any light source of the at least one light source is started to emit the light, imaging the projection of the light that is emitted by the any light source and passes through the plurality of light-transmissive holes on the auxiliary imaging element, and obtaining the projection image corresponding to the any light source; and a processor configured to determine the illumination angle data of the microscope based on the reference image and the at least one projection image.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an application scenario of a system for calibrating an illumination angle of a microscope according to some embodiments of the present disclosure;

FIG. 2 is a schematic diagram illustrating an exemplary distance adjustment assembly according to some embodiments of the present disclosure;

FIG. 3 is a block diagram illustrating an exemplary system for calibrating an illumination angle of a microscope according to some embodiments of the present disclosure;

FIG. 4 is a block diagram illustrating another exemplary system for calibrating an illumination angle of a microscope according to some embodiments of the present disclosure;

FIG. 5 is a flowchart illustrating an exemplary process for calibrating an illumination angle of a microscope according to some embodiments of the present disclosure;

FIG. 6 is a flowchart illustrating an exemplary process for determining illumination angle data of a microscope according to some embodiments of the present disclosure;

FIG. 7 is a schematic diagram illustrating an exemplary process for determining illumination angle data of a microscope according to some embodiments of the present disclosure;

FIG. 8 is a schematic diagram illustrating an exemplary initial image and exemplary projection images according to some embodiments of the present disclosure;

FIG. 9 is a schematic diagram illustrating an exemplary intersection position according to some embodiments of the present disclosure;

FIG. 10 is a schematic diagram illustrating comparison results of illumination angles of LEDs between with and without calibration according to some embodiments of the present disclosure; and

FIGS. 11A-11D are schematic diagrams illustrating exemplary light-transmissive holes according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, the drawings described below are only some examples or embodiments of the present disclosure. Those skilled in the art, without further creative efforts, may apply the present disclosure to other similar scenarios according to these drawings. Unless apparent from the locale or otherwise stated, like reference numerals represent similar structures or operations throughout the several views of the drawings.

It will be understood that the term system, device, unit, and/or module used herein are one method to distinguish different components, elements, parts, sections, or assembly of different levels in ascending order. However, the terms may be displaced by another expression if they achieve the same purpose.

As used in the disclosure and the appended claims, the singular forms a, an, a kind of, and/or the may include plural forms unless the content clearly indicates otherwise. In general, the terms comprise, comprises, and/or comprising, include, includes, and/or including, merely prompt to include steps and elements that have been clearly identified, and these steps and elements do not constitute an exclusive listing. The methods or devices may further include other steps or elements.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

A feasible method for calibrating an illumination angle based on an image spectral distribution feature may include two operations: first, the illumination angle of a bright-field image is calibrated by analyzing a spectra of an image generated under a tilted plane-wave illumination; second, the illumination angles of the bright-field image and a dark-field image are finely calibrated based on a spectral correlation. The method may have a robustness in the calibration of angles of a variety of microscope illumination devices, such as a flat panel Light Emitting Diode (LED) illumination, a laser scanning illumination, dome LED illumination, etc. However, a circular edge detection used in this method requires a sufficiently broad range of Fourier spectrum of the image(s) to include boundaries of two separate circles within an image intensity spectrum, and therefore the image(s) are required to have a smaller sample pixel than a sample pixel required by a sample theorem.

Furthermore, another feasible method for iteratively correcting a global position or an illumination angle of an illumination device may be realized based on a simulation annealing method and a nonlinear regression. This method may have a relatively high efficiency and a relatively strong noise-resistance. A global position misalignment model may be introduced to update parameters in addition to image reconstruction, thereby improving the processing efficiency of the method.

In the methods mentioned above, the illumination device of the microscope (e.g., LEDs) is arranged in a regular manner and a pre-alignment of the LED positions needs to be performed. The illumination angle calibration is performed in the image reconstruction process. If a significant misalignment is presented in the illumination angle, the methods may be time-consuming.

To realize convenient, effective and accurate calibration of the illumination angle, the present disclosure provides a calibration device to facilitate the calibration process and methods thereof. An initial image may be obtained by imaging the calibration device, and illumination angle data of the microscope may be determined based on the initial image. The illumination angle data may be stored in a storage device. When image data of the object(s) are generated, the illumination angle data may be used to correct the image data, thereby improving the performance of image reconstruction. The calibration of the illumination angle is realized without relying on the priori information of the illumination device and the imaged object, and a high-quality image reconstruction result can be obtained.

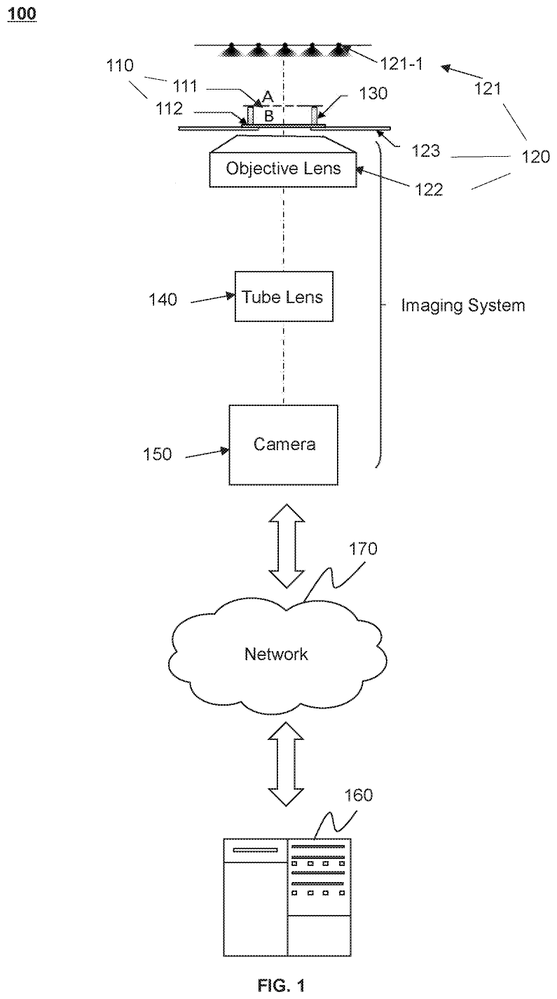

FIG. 1 is a schematic diagram illustrating an application scenario of a system 100 for calibrating an illumination angle of a microscope according to some embodiments of the present disclosure. In some embodiments, the application scenario of the system 100 for calibrating the illumination angle(s) of the microscope may include a calibration device 110, a microscope 120, a distance adjustment assembly 130, a tube lens 140, a camera 150, a processor 160, and/or a network 170. In some embodiments, the application scenario of the system 100 for calibrating the illumination angle(s) of the microscope may further include a storage device and/or a user terminal (not shown in FIG. 1).

The calibration device 110 may be configured to generate illumination angle data of the microscope for further calibration (e.g., image data calibration in image reconstruction process). In some embodiments, the calibration device 110 may include a phantom 111.

The phantom 111 may include a mask through which light can be transmitted. In some embodiments, the phantom 111 may include at least two light-transmissive holes 111-1 (see FIGS. 11A-11D). The light may transmit through the light-transmissive holes 111-1 of the phantom 111 to reach a focal plane of the microscope. In some embodiments, the phantom 111 may be made of a light-impermeable material. For example, the phantom 111 may be made of a metal material, a ceramic material, a polymer material, or the like, or any combination thereof. In some embodiments, a shape of the phantom 111 may be square, rectangular, polygonal, or the like, or any combination thereof.

The light-transmissive holes 111-1 may be through-holes. As shown in FIG. 1, the light-transmissive holes 111-1 may pass through both side surfaces of the phantom 111, such that the light emitted by the illumination device 121 reaches on a side A of the phantom 111 can pass through the phantom 111 and reach a side B of the phantom 111. For descriptive convenience, as may be seen from a paper view illustrated in FIG. 1, the side A illustrates an upper side of the phantom 111 and the side B illustrates a lower side of the phantom 111. It may be understood that in an actual application, the light does not necessarily transmit along the direction illustrated in FIG. 1, but may transmit along any other direction according to actual needs.

In some embodiments, shapes, intervals, counts, and/or sizes of the light-transmissive holes 111-1 may be arbitrarily designed or designed according to an illumination angle of the illumination device 121 of the microscope 120. For example, the shape of each of the light-transmissive holes 111-1 may be a circular shape, a cross, a star, etc., to facilitate the determination of their positions in generated image(s) (e.g., a reference image, projection image(s)). More descriptions of the intervals, counts, sizes, etc., of the light-transmissive holes 111-1 may be found in FIGS. 11A-11D and their related descriptions.

In some embodiments, the calibration device 110 may further include an auxiliary imaging element 112. The auxiliary imaging element 112 may be configured to assist in obtaining the illumination angle data of the microscope. In some embodiments, as shown in FIG. 1, the auxiliary imaging element 112 may be placed on a sample observation stage 123 on side B of the phantom 111. The auxiliary imaging element 112 may facilitate to obtain at least one projection image 820 by adjusting a position of an objective lens 122 of the imaging system (i.e., the imaging system of the microscope) to make the camera 150 of the imaging system be able to obtain a projection of the light emitted by at least one light source 121-1 of the illumination device 121 passing through the at least two light-transmissive holes 111-1 on the auxiliary imaging element 112. The imaging system may include the objective lens 122, the tube lens 140, and the camera 150 in microscope 120. A position of the objective lens 122 may refer to a position of the upper surface of the objective lens 122.

In some embodiments, the auxiliary imaging element 112 may be a glass sheet made of an optical scattering material. For example, the auxiliary imaging element 112 may be made of quartz glass, plain white glass, ultra-white glass, and any other type of scattering and light homogenizing material. In some embodiments, the shape of the auxiliary imaging element 112 may be square, rectangular, polygonal, or the like. For example, the auxiliary imaging element 112 may be a 25×75 mm frosted biological slide.

In some embodiments, at least one of the both sides of the auxiliary imaging element 112 parallel to a surface of the objective lens 122 may be provided with an outer layer (e.g., of a film, or glass, or the like) for eliminating an effect of refraction of the light reaching the glass sheet. In some embodiments, the outer layer may be arranged on a side surface of the auxiliary imaging element 112 away from the objective lens 122. In such case, when the objective lens 122 focuses on the above outer layer, the effect of the refraction of the light passing onto the glass sheet may be eliminated, thereby facilitating obtaining more accurate projection images(s), and/or illumination angle data. For example, the outer layer of the auxiliary imaging element 112 may be a frosted layer, and the frosted layer may be obtained by processing such as chemical etching, physical grinding, or the like. Merely by way of example, the auxiliary imaging element 112 may be a glass sheet with a frosted layer on one side and a non-frosted surface on the other side, in which the frosted layer faces away from the objective lens 122, and the non-frosted side is arranged toward the objective lens 122.

The microscope 120 may be an instrument that images fine structure(s) of substance at very high magnification according to a principle of electron optics.

The illumination device 121 may be configured to provide at least one light source for the microscope 120. In some embodiments, the illumination device 121 may be or include flat panel LED(s) or dome LED(s), or may use laser scanning illumination, or the like. In some embodiments, the illumination device 121 may include at least one light source 121-1.

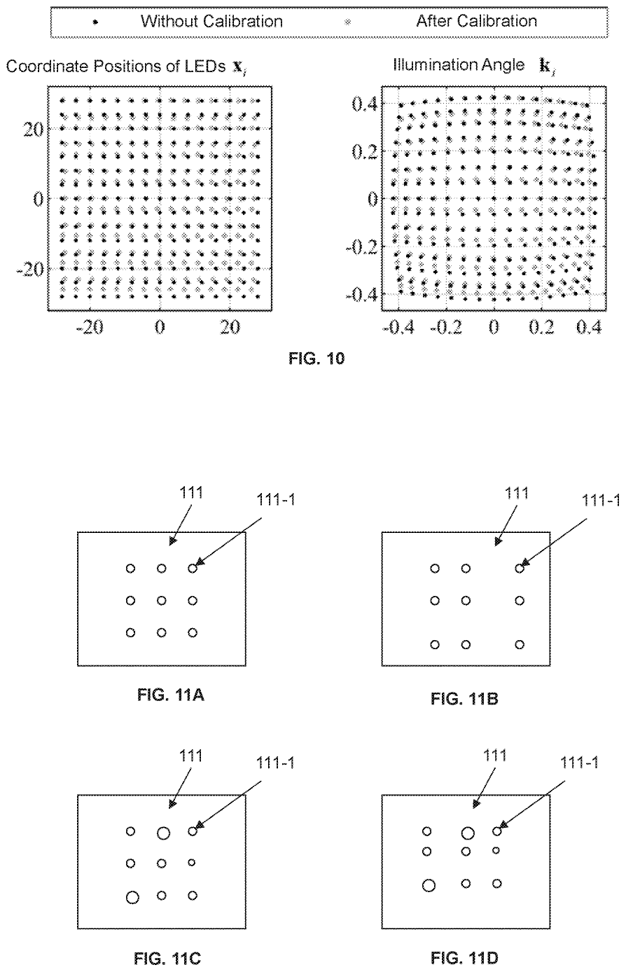

A light source 121-1 refers to a lighting unit of the illumination device 121. The light sources 121-1 may provide tilted illumination light at different angles. For example, as shown in FIG. 10, take the flat panel LED lighting as an example, the light sources 121-1 may be an array of 15×15 light beads.

The objective lens 122 may include a lens group including a combination of a plurality of lenses. The objective lens 122 may magnify the imaged object. Optical parameters of the objective lens 122 may be related to or affect the imaging quality.

The sample observation stage 123 may be a component that supports the target object.

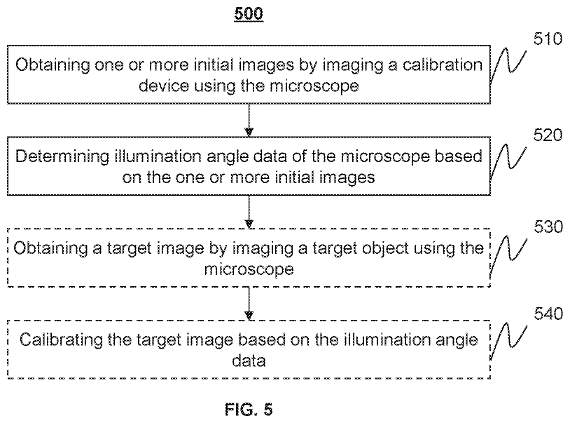

In some embodiments, the calibration device 110 may further include a distance adjustment assembly 130. The distance adjustment assembly 130 may be configured to adjust a distance between the phantom 111 and the auxiliary imaging element 112. In some embodiments, as shown in FIG. 1, the distance adjustment assembly 130 may be arranged between the phantom 111 and the auxiliary imaging element 112. The distance adjustment assembly 130 may cause the light emitted by the at least one light source 121-1 of the illumination device 121 to pass through the at least two light-transmissive holes 111-1, propagate in the air for a certain distance, and reach the auxiliary imaging element 112. Lights emitted from different light sources may have different propagation paths to reach the auxiliary imaging element 112. More descriptions of the calibration process using the calibration device 110 may be found elsewhere in the present disclosure (e.g., FIGS. 5-9 and descriptions thereof).

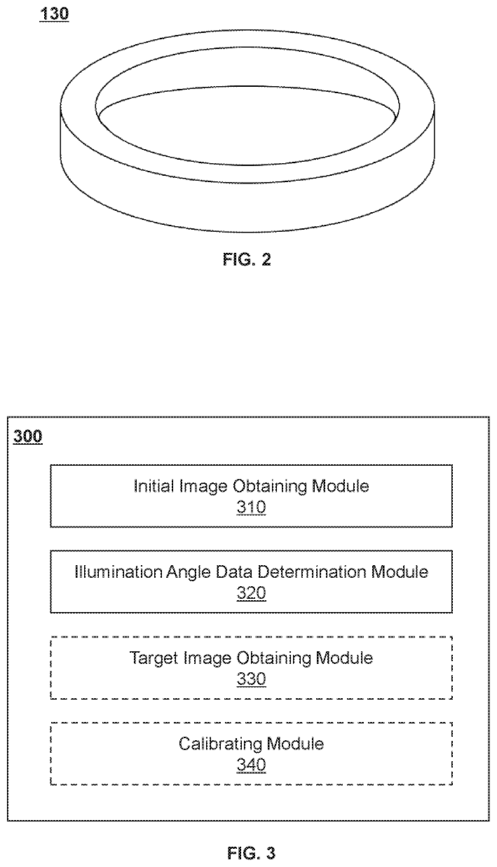

In some embodiments, as shown in FIG. 2, the distance adjustment assembly 130 may have a ring-shaped table structure with a central through-hole to allow the light (that is emitted by the at least one light source 121-1 of the illumination device 121 and passes through the at least two light-transmissive holes 111-1) be projected onto a surface (e.g., an upper surface) of the auxiliary imaging element 112. In some embodiments, the distance adjustment assembly 130 may be of any other shape in addition to a circular structure, such as a square ring-shaped table, a polygonal ring-shaped table, etc. In some embodiments, a height of the ring-shaped table structure may be 2 mm, 3 mm, 4 mm, etc. If the height of the ring-shaped stage structure is too low, the distance that the light emitted by the light source 121-1 propagates in the air may be too small, which may be not conducive to subsequent illumination angle calibration. If the height of the ring-shaped stage structure is too high, the objective lens 122 may reach the sample observation stage 123 to image the phantom 111. In some embodiments, the distance adjustment assembly 130 may further include a lifting table, a threaded adjuster, a spring adjuster, and/or any other component.

In some embodiments, the distance adjustment assembly 130 may be made of a 3D printed resin material, a machined metal material, or the like. The material and fabrication process of the distance adjustment assembly 130 is not limited in the present disclosure.

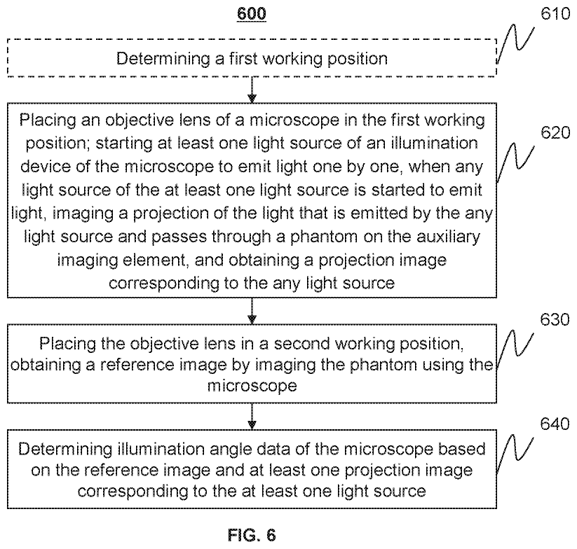

The tube lens 140 refers to a device configured to observe and magnify the imaged object. The camera 150 refers to a device configured to obtain image(s) by imaging object(s). More description of the object (e.g., a target object) and the image(s) (e.g., a target image) may be found elsewhere in the present disclosure (e.g., FIG. 6 and related descriptions thereof).

The processor 160 may be configured to process data related to the system for calibrating the illumination angle of the microscope. For example, the processor 160 may obtain one or more initial images by imaging the calibration device 110 using the microscope 120. Further, the processor 160 may determine the illumination angle data of the microscope 120 based on the initial image(s). In some embodiments, the processor 160 may be a single server or a server group. The server group may be centralized or distributed. In some embodiments, the processor 160 may be local or remote. In some embodiments, the processor 160 may be implemented on a cloud platform. Merely by way of example, the cloud platform may include a private cloud, a public cloud, a hybrid cloud, a community cloud, a distributed cloud, an on-premises cloud, a multi-tiered cloud, etc., or any combination thereof. In some embodiments, the processor 160 may be integrated or installed in the calibration device 110. In some embodiments, the processor 160 may be integrated or installed in the microscope 120.

The network 170 may include any suitable wired or wireless network that may facilitate the exchange of information and/or data. In some embodiments, one or more components of the calibration device 110, one or more components of the microscope 120, the distance adjustment assembly 130, the tube lens 140, the camera 150, the processor 160, the storage device, the user terminal, etc., may communicate the information and/or data with one or more other components of the application scenario of the system 100 through the network 170.

In some embodiments, the application scenario of the system 100 may further include some or more other devices, such as, for example, a storage device and/or a user terminal, which is not limited in the present disclosure.

The storage device may store data, instructions, and/or any other information. In some embodiments, the storage device may store the data and/or instructions related to calibration of the illumination angle of the microscope. For example, the storage device may store the initial image(s). As another example, the storage device may store the instructions for processing the initial image(s) to determine the illumination angle data of the microscope.

In some embodiments, the storage device may be connected to the network 170 to communicate with the one or more other components of the application scenario of the system 100 (e.g., the calibration device 110, the microscope 120, the distance adjustment assembly 130, the tube lens 140, the camera 150, the processor 160, the storage device, the user terminal, etc.). The one or more components of the application scenario of the system 100 may access the data or instructions stored in a storage device through the network 170. In some embodiments, the storage device may be a portion of the processor 160.

The user terminal may include a mobile device, a tablet, a laptop, etc., or any combination thereof. In some embodiments, the user terminal may be a portion of the processor 160.

FIG. 3 is a block diagram illustrating an exemplary system for calibrating an illumination angle of a microscope according to some embodiments of the present disclosure. In some embodiments, the system 300 for calibrating the illumination angle of the microscope may include an initial image obtaining module 310 and an illumination angle data determination module 320. In some embodiments, the system 300 may further include a target image obtaining module 330 and/or a calibrating module 340.

The initial image obtaining module 310 may be configured to obtain the initial image(s) by imaging a calibration device (e.g., the calibration device 110) using the microscope. In some embodiments, the calibration device may include a phantom (e.g., the phantom 111). The phantom may include at least two light-transmissive holes. In some embodiments, the calibration device may further include an auxiliary imaging element (e.g., the auxiliary imaging element 112). In some embodiments, the initial image obtaining module 310 may further be configured to obtain a reference image by imaging the at least two light-transmissive holes using the microscope; and start at least one light source of an illumination device of the microscope to emit light one by one, when any light source of the at least one light source is started to emit light, image a projection of the light that is emitted by the any light source and passes through the at least two light-transmissive holes on the auxiliary imaging element, and obtain a projection image corresponding to the any light source. In some embodiments, the initial image obtaining module 310 may be further configured to place an objective lens of the microscope at a first working position, and start the at least one light source of the illumination device of the microscope to emit light one by one. In some embodiments, the initial image obtaining module 310 may be further configured to place the objective lens at a second working position, and obtain the reference image by imaging the at least two light-transmissive holes using the microscope. In some embodiments, a distance between the first working position and the second working position may be related to a distance between the phantom and the auxiliary imaging element. In some embodiments, the initial image obtaining module 310 may be further configured to determine the first working position, including: placing the auxiliary imaging element on a sample observation stage of the microscope, focusing the objective lens on a surface of the auxiliary imaging element facing the illumination device, and designating a position of the objective lens as the first working position.

The illumination angle data determination module 320 may be configured to determine the illumination angle data for the microscope based on the initial image(s). In some embodiments, the illumination angle data determination module 320 may be further configured to determine the illumination angle data based on first positions of the at least two light-transmissive holes in the reference image and second positions of the at least two light-transmissive holes in the at least one projection image corresponding to the at least one light source. In some embodiments, the illumination angle data determination module 320 may be further configured to, for each light source of the at least one light source of the illumination device, for each hole of the at least two light-transmissive holes, determine a straight line based on a first position of the each hole in the reference image and the second position of the each hole in the projection image corresponding to the each light source; determine the intersection position of the at least two straight lines based on the at least two straight lines corresponding to the at least two light-transmissive holes; and determine the illumination angle data corresponding to the each light source based on the intersection position and a preset relationship.

The target image obtaining module 330 may be configured to obtain a target image by imaging a target object (i.e., an objected of interest to be observed) using the microscope.

The calibrating module 340 may be configured to calibrate the target image based on the illumination angle data.

More specific descriptions of the initial image obtaining module 310, the illumination angle data determination module 320, the target image obtaining module 330, and the calibrating module 340 may be found elsewhere in the present disclosure (e.g., FIG. 5 and its related descriptions).

It should be understood that the system 300 and its modules shown in FIG. 3 may be implemented in various manners. It should be noted that the above descriptions of the system 300 and its modules are merely provided for the purpose of illustrative convenience, and are not intended to limit the present disclosure to the scope of the cited embodiments. For those skilled in the art, after understanding the principle of the system, it may be possible to make any combination of the individual modules or form a sub-system to connect with other modules without departing from this principle. In some embodiments, the initial image obtaining module 310, the illumination angle data determination module 320, the target image obtaining module 330, and the calibrating module 340 disclosed in FIG. 3 may be different modules in a single system, or a single module may realize the functions of two or more of the aforementioned modules. For example, the modules may share a storage module, or each module may have a respective storage module. Such variations are within the scope of protection of the present disclosure.

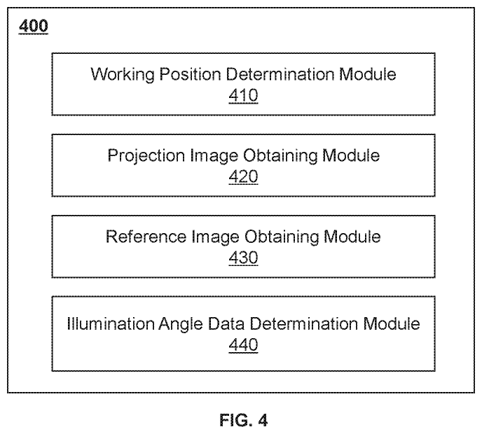

FIG. 4 is a block diagram illustrating another exemplary system for calibrating an illumination angle of a microscope according to some embodiments of the present disclosure. In some embodiments, the system 400 for calibrating the illumination angle of the microscope may include a working position determination module 410, a projection image obtaining module 420, a reference image obtaining module 430, and an illumination angle data determination module 440.

The working position determination module 410 may be configured to determine a first working position and/or a second working position of the objective lens of the microscope. In some embodiments, the first working position may be determined according to the auxiliary imaging element. In some embodiments, the second working position may be determined according to the phantom.

The projection image obtaining module 420 may be configured to place the objective lens of the microscope at the first working position; start the at least one light source of the illumination device of the microscope to emit the light one by one, when the any light source of the at least one light source is started to emit the light, image the projection of the light that is emitted by the any light source and passes through the phantom on the auxiliary imaging element, and obtain the projection image corresponding to the any light source.

The reference image obtaining module 430 may be configured to place the objective lens at the second working position; and obtain the reference image by imaging the phantom using the microscope.

The illumination angle data determination module 440 may be configured to determine the illumination angle data of the microscope based on the reference image and the at least one projection image corresponding to the at least one light source. In some embodiments, the illumination angle data determination module 440 may be further configured to determine the illumination angle data based on first positions of the at least two light-transmissive holes in the reference image and second positions of the at least two light-transmissive holes at least one projection image corresponding to the at least one light source. In some embodiments, the illumination angle data determination module 440 may be further configured to, for each light source of the at least one light source of the illumination device, for each hole of the at least two light-transmissive holes, determine the straight line based on the first position of the each hole in the reference image and the second position of the each hole in the projection image corresponding to the each light source; determine the intersection position of the at least two straight lines based on the at least two straight lines corresponding to the at least two light-transmissive holes; and determine the illumination angle data corresponding to the each light source based on the intersection position and the preset relationship.

More descriptions regarding the working position determination module 410, the projection image obtaining module 420, the reference image obtaining module 430, and the illumination angle data determination module 440 may be found elsewhere in the present disclosure (e.g., FIGS. 6-9 and their related descriptions).

It should be understood that the system 400 and its modules shown in FIG. 4 may be implemented in various manners. It should be noted that the above descriptions of the system 400 and its modules are merely provided for the purpose of illustrative convenience, and are not intended to limit the present disclosure to the scope of the cited embodiments. For those skilled in the art, after understanding the principle of the system, it may be possible to make any combination of the individual modules or form the sub-system to connect with other modules without departing from this principle. In some embodiments, the working position determination module 410, the projection image obtaining module 420, the reference image obtaining module 430, and the illumination angle data determination module 440 disclosed in FIG. 4 may be different modules in the single system, or a single module may realize the functions of two or more of the aforementioned modules. For example, the modules may share a storage module, or each module may have a respective storage module. Such variations are within the scope of protection of the present disclosure.

FIG. 5 is a flowchart illustrating an exemplary process for calibrating an illumination angle of a microscope according to some embodiments of the present disclosure. As shown in FIG. 5, process 500 may include one or more of the following operations. In some embodiments, one or more operations of the process 500 shown in FIG. 5 may be implemented in the system for calibrating the illumination angle of the microscope shown in FIG. 1. For example, the process 500 shown in FIG. 5 may be stored in the storage device in the form of instructions and invoked and/or executed by the processor 160.

In 510, one or more initial images may be obtained by imaging a calibration device using the microscope. In some embodiments, operation 510 may be performed by the initial image obtaining module 310.

The initial image(s) may refer to image(s) generated using calibration device and may be used to determine the illumination angle data of the microscope. In some embodiments, the initial image(s) may include a reference image and/or at least one projection image.

The reference image may refer to or include an image that realistically reflects the shape, size, and/or relative positions of the at least two light-transmissive holes in the phantom.

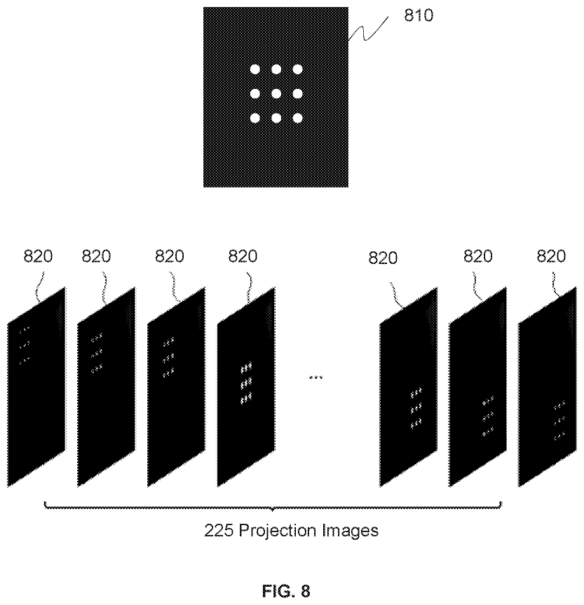

A projection image may refer to or include an image reflecting the projection of the light that is emitted by the at least one light source and passes through the at least two light-transmissive holes on the auxiliary imaging element. In some embodiments, the count of projection images may correspond to the count of light sources. In some embodiments, the projection images and the light sources may be in one-to-one correspondence. That is, for any one light source, there may be a projection image of the light that is emitted by the light source and passes through the at least two light-transmissive holes on the auxiliary imaging element. For example, as shown in FIG. 8, if the count of light sources is 15×15 (i.e., 255), the count of projection images may also be 255.

In some embodiments, the processor may obtain the reference image by imaging the at least two light-transmissive holes using the microscope. More descriptions of obtaining the reference image of the phantom may be found in FIG. 6 and its related descriptions.

In some embodiments, the processor may start the at least one light source of the illumination device of the microscope to emit the light one by one, when the any light source of the at least one light source is started to emit the light, image the projection of the light that is emitted by the any light source and passes through the at least two light-transmissive holes on the auxiliary imaging element, and obtain the projection image corresponding to the any light source. More descriptions of obtaining the at least one projection image may be found in FIG. 6 and its related descriptions.

In 520, the illumination angle data of the microscope may be determined based on the initial image(s). In some embodiments, operation 520 may be performed by the illumination angle data determination module 320.

The illumination angle data of the microscope may refer to or include an angle between a line connecting each light source (e.g., the position of each light source of the illumination device) and a focal point, and the optical axis of the microscope. The focal point refers to a point at which the objective lens is focused on the surface of the auxiliary imaging element toward the illumination device. The optical axis refers to an axis of symmetry of the microscope.

In some embodiments, the processor 160 may determine the illumination angle data based on the first positions of the at least two light-transmissive holes in the reference image and the second positions of the at least two light-transmissive holes in at least one projection image corresponding to the at least one light source. More descriptions of determining the illumination angle data may be found in FIG. 6 and its related descriptions.

It should be understood that after the illumination angle data is determined, the processor 160 may store the illumination angle data in a storage device. After the target object is imaged subsequently, the processor 160 may directly obtain (e.g., retrieve) the illumination angle data from the storage device and perform a calibration operation on the image data of the target object using the illumination angle data in the reconstruction process of the image(s) of the target object, without repeatedly using the calibration device to calibrate the illumination angle of the microscope, thereby improving efficiency.

In some embodiments, the process 500 may further include operations 530 and/or operation 540.

In 530, a target image of the target object may be obtained by imaging the target object using the microscope. In some embodiments, operation 530 may be performed by the target image obtaining module 330.

The target object may be a sample or an object of interest to be microscopically imaged. For example, the target object may include human breast cancer cells (MCF-7), human hepatocellular carcinoma cells (HepG2), mouse macrophages (RAW 264.7), or the like, or any combination thereof. The target image may be an image of the target object generated by the microscope. The target image may reflect information of different frequency domain components of the target object. In some embodiments, the processor 160 may cause the microscope to image the target object under different directional plane wave illumination modulations by using the camera of the microscope, to obtain the target image of the target object.

In 540, the target image may be calibrated based on the illumination angle data. In some embodiments, operation 540 may be performed by the calibrating module 340.

In some embodiments, the processor 160 may retrieve the illumination angle data stored in the storage device. In an exemplary reconstruction process, the processor 160 may input the illumination angle data and the target image into an imaging model of the imaging system to calibrate errors of the target image caused by illumination angle errors, thereby obtaining a high-quality image reconstruction result. Exemplary imaging models may include a Fourier Ptychographic Microscopy (FPM), an Optical diffraction tomography (ODT), or the like, or any combination thereof.

In some embodiments of the present disclosure device, by imaging the calibration device through the microscope, the initial image(s) are obtained, the illumination angle data of the microscope is determined subsequently, the target image of the target object can be calibrated using the illumination angle data, and high-quality image reconstruction results can be obtained. In addition, the method provided in the present disclosure is an off-line calibration method, and is performed prior to imaging and image reconstruction of the target object. Besides, the method provided in the present disclosure is a geometric calibration method and does not need a local search operation. Therefore, there is no requirement for the priori information of the illumination angle and no need for pre-alignment of the illumination device. Furthermore, the method provided in the present disclosure does not rely on and is independent of the image reconstruction process of the target object, and therefore there is no special requirement or limitation on the sample rate of the image.

It should be noted that the foregoing descriptions of the microscope illumination angle calibration process are merely provided for the purpose of illustration and are not intended to limit the scope of the present disclosure. For those skilled in the art, various amendments and variations to the microscope illumination angle calibration process may be made under the teaching of the present disclosure. However, these amendments and variation remain within the scope of the present disclosure. In some embodiments, the processor may further adjust the positions of the light sources 121-1 of the illumination device 121 by using the determined illumination angle data of the microscope, thereby reducing an alignment error of the light sources to improve imaging quality of the microscope.

FIG. 6 is a flowchart illustrating an exemplary process for determining illumination angle data of a microscope according to some embodiments of the present disclosure. In some embodiments, one or more operations of the process 600 shown in FIG. 6 may be implemented in the system 100 shown in FIG. 1. For example, process 600 shown in FIG. 6 may be stored in a storage device in the form of instructions and invoked and/or executed by the processor 160.

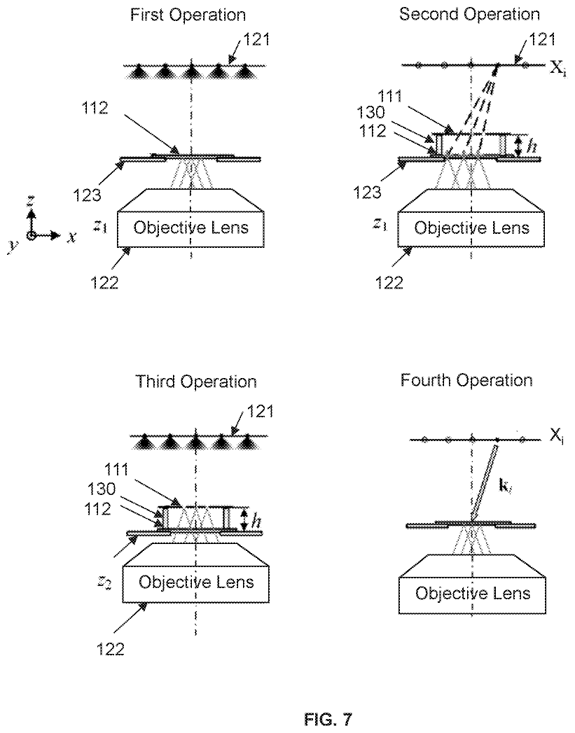

FIG. 7 is a schematic diagram illustrating an exemplary process for determining illumination angle data of a microscope according to some embodiments of the present disclosure. The first, second, third and fourth operations in FIG. 7 may correspond to operations 610 to 640, respectively. An xy plane of the xyz coordinate system in FIG. 7 may correspond to a focal plane (i.e., an object focal plane) of the microscope. A focal point (when the objective lens is focused on the surface of the auxiliary imaging element toward the illumination device) on the focal plane (i.e., object focal point) may be designated as an origin of the xy plane. A z axis of the xyz coordinate system may correspond to a movement direction of the objective lens of the microscope (i.e., a direction perpendicular to the focal plane, or a direction of the optical axis) during focusing. A z coordinate of the focal point (when the objective lens is focused on the surface of the auxiliary imaging element toward the illumination device) on the focal plane may be designated as a z-axis origin. The focal plane refers to a plane that passes through the focal point and is perpendicular to the direction of the focusing movement. When the objective lens is focused on a surface of the auxiliary imaging element toward the illumination device, the focal plane may correspond to the surface of the auxiliary imaging element toward the illumination device.

In the following descriptions, the illumination device 121 with flat panel LEDs and the phantom 111 including 9 light-transmissive holes 111-1 are taken as an example. The LED light beads (i.e., light sources 121-1 of the illumination device 121) are arranged as a 15×15 array with an interval of about 4 mm. The 9 light-transmissive holes 111-1 are arranged as a 3×3 array. It may be appreciated that the method for illumination angle calibration for other illuminations (e.g., the laser scanning illumination, the dome LED illumination) is similar to the method for illumination angle calibration for the flat panel LED illumination.

In 610, a first working position may be determined by using the auxiliary imaging element. In some embodiments, operation 610 may be performed by the working position determination module 410. In some embodiments, operation 610 may be performed manually.

The first working position refers to a position where the objective lens of the microscope needs to be located when obtaining the projection image corresponding to the at least one light source.

In some embodiments, as shown in the first operation in FIG. 7, the processor 160 may control a robotic arm to place the auxiliary imaging element 112 on the sample observation stage 123, focus the objective lens 122 on the surface of the auxiliary imaging element 112 toward the illumination device 121, and designate a position of the objective lens 122 as the first working position. The first working position may be noted as z₁ and recorded. In some embodiments, prior to focusing, the processor 160 may control the robotic arm to print or write a mark on the surface of the auxiliary imaging element 112 to facilitate the focusing process. For example, suppose the auxiliary imaging element 112 is a glass sheet with a single frosted layer, the non-frosted layer of the sheet of glass facing the objective lens 122, then the position of the objective lens 122 may be noted as z₁ when the objective lens 122 is focused on the surface of the frosted layer of the auxiliary imaging element 112.

It should be understood that the above operation executed by the processor 160 for controlling the robotic arm may be executed by an operator for controlling the robotic arm through a handle, or performed manually by the operator directly. Using the processor 160 to control the robotic arm to execute the operations may provide a high degree of automation and intelligence. A manual execution may provide a high degree of flexibility with a simple equipment. Similarly, the following operations are performed automatically, semi-automatically, or manually, which will not be repeated.

In 620, the at least one light source of the illumination device of the microscope may be started to emit light one by one. When any light source of the at least one light source is started to emit the light, a projection of the light that is emitted by the any light source and passes through the phantom on the auxiliary imaging element may be imaged, and the projection image corresponding to the any light source may be obtained. In some embodiments, operation 620 may be performed by the projection image obtaining module 420.

In some embodiments, the distance adjustment assembly 130 may have a ring-shaped table structure, as shown in the second operation in FIG. 7, the processor 160 may place the objective lens 122 of the microscope 120 to the first working position z₁, place the phantom 111 on top of the auxiliary imaging element 112 toward the illumination device 121, and place the distance adjustment assembly 130 between the phantom 111 and the auxiliary imaging element 112 so that the light emitted from at least one light source 121-1 of the illumination device 121 may be projected on the auxiliary imaging element 112 through the light-transmissive hole 111-1 of the phantom 111. Since the camera at this time images the surface of the auxiliary imaging element 112 facing toward the illumination device 121, the objective lens 122 needs to be placed at the first working position z₁.

It should be understood that the distance adjustment assembly 130 makes the height of the phantom 111 be higher than the height of the auxiliary imaging element 112, so that the light emitted by the at least one light source 121-1 of the illumination device 121 may pass through the at least two light-transmissive holes 111-1, and may be projected to different positions on an upper surface of the auxiliary imaging element 112 after propagating through the air for a certain distance.

In some embodiments, the processor 160 may start at least one light source 121-1 of an illumination device 121 of the microscope 120 to emit the light one by one. When the any light source of the at least one light source is started to emit the light, a projection of the light that is emitted by the at least one light source 121-1 and passes through the light-transmissive holes 111-1 of the phantom 111 on the auxiliary imaging element may be imaged, to obtain at least one projection image 820. Starting the least one light source 121-1 of the illumination device 120 of the microscope 120 to emit light one by one means that the processor 160 controls the at least one light source 121-1 to emit light sequentially. Merely by way of example, as shown in FIG. 8, 225 LED light beads are sequentially illuminated to obtain 225 projection images 820, and each bright spot on each projection image 820 corresponds to a projection of the light passing through a light-transmissive hole 111-1 of the phantom 111 on the auxiliary imaging element 112 when a single LED light bead is illuminated. Since a total of 225 LEDs are sequentially illuminated in this example, there are 225 projection images in FIG. 8.

In 630, the objective lens may be placed at a second working position. The reference image may be obtained by imaging the at least two light-transmissive holes using the microscope. In some embodiments, operation 630 may be performed by the reference image obtaining module 430.

The second working position refers to a position of the objective lens of the microscope when the reference image of the phantom is obtained.

In some embodiments, the processor 160 may focus the objective lens 122 on the surface of the phantom 111 toward the distance adjustment assembly 130. When the objective lens 122 focuses on the surface of the phantom 111 toward the distance adjustment assembly 130, the position of the objective lens 122 may be noted as z₂, and recorded.

Since a distance between the upper surface of the objective lens 122 and the focal plane is constant, a distance between the first working position and the surface of the auxiliary imaging element 112 facing the illumination device 121 may be equal to a distance between the second working position and the surface of the phantom 111 facing the distance adjustment assembly 130. Therefore, the distance between the first working position and the second working position may be equal to the distance between the phantom 111 and the auxiliary imaging element 112. That is, the distance between the first working position and the second working position may be related to the distance between the phantom and the auxiliary imaging element. The distance between the phantom 111 and the auxiliary imaging element 112 refers to a distance between the surface of the phantom 111 toward the distance adjustment assembly 130 and a surface of the auxiliary imaging element 112 toward the illumination device 121.

In some embodiments, the distance adjustment assembly 130 may have a ring-shaped table structure, and the distance between the first working position and the second working position may be equal to the height of the distance adjustment assembly 130. Accordingly, if the first working distance z₁ has been determined, the processor 160 may move the objective lens 122 upwards by a distance equal to the height of the distance adjustment assembly 130, and designate the position of the objective lens 122 at that point as the second working position, which is noted as z₂ and recorded.

In some embodiments, as shown in the third operation in FIG. 7, the objective lens 122 of the microscope 120 may be placed at the second working position z₂, and the processor 160 may control one or more of the light sources 121-1 of the illumination device 121 to illuminate simultaneously, and obtain the reference image 810 by imaging the at least two light-transmissive holes 111-1 of the phantom 111 using the microscope 120. Merely by way of example, as shown in FIG. 8, a count of the reference image 810 may be one. The reference image 810 of the phantom may truly reflect the shapes, sizes, and relative positions of the nine light-transmissive holes on the surface of the phantom 111 toward the distance adjustment assembly 130. It should be appreciated that the objective lens 122 may be placed at the second working position z₂ since the camera at this time images the surface of the phantom 111 toward the distance adjustment assembly 130.

In some embodiments, since only the phantom 111 needs to be illuminated at this time, alternatively, the processor 160 may use other light source(s) to illuminate the phantom 111 without controlling the light source(s) 121-1 of the illumination device 121 to emit the light. For example, the processor 160 may control a single light source 121-1 of the illumination device 121 for illumination. As another example, the processor 160 may use an illumination device other than a flat panel LED for illumination.

In 640, the illumination angle data of the microscope may be determined based on the reference image and at least one projection image corresponding to the at least one light source. In some embodiments, operation 640 may be performed by the illumination angle data determination module 440.

In some embodiments, for each of the at least one light source of the illumination device, the processor 160 may obtain the illumination angle data of the light source, which may include: for the each light source of the at least one light source of the illumination device, for the each hole of the at least two light-transmissive holes, determining the straight line based on the first position of the each hole in the reference image and the second position of the each hole in the projection image corresponding to the each light source; determining the intersection position of the at least two straight lines based on the at least two straight lines corresponding to the at least two light-transmissive holes; and determining the illumination angle data corresponding to the each light source based on the intersection position and the preset relationship.

In some embodiments, for the p^{th} light-transmissive hole of the at least two light-transmissive holes 111-1, a coordinate position of the p^{th} light-transmissive hole in the reference image 810 may be

$${x}_{o}^{p} = ( {x}_{o}^{p} , {y}_{0}^{p} , h ) ,$$

in which

$${x}_{o}^{p} , {y}_{o}^{p}$$

is a horizontal coordinate of the position of the p^{th} light-transmissive hole in the reference image 810; p=1, 2, . . . , N, N being a total count of light-transmissive holes; h=z₂−z₁. According to the description above, h may be a distance between the surface of the phantom 111 toward the distance adjustment assembly 130 and the surface of the auxiliary imaging element 112 toward the illumination device 121. If the distance adjustment assembly 130 has the ring-shaped table structure, h may be equal to the height of the distance adjustment assembly 130. Since the focal point (when the objective lens is focused on the surface of the auxiliary imaging element toward the illumination device) on the focal plane is the z-axis origin, a coordinate of the z-axis of the position of the p^{th} light-transmissive hole in the reference image 810 of the phantom may be h.

It should be noted that the person skilled in the art may use other process(es) to obtain the coordinate position of the p^{th} light-transmissive hole in the reference image 810 (when the objective lens 122 is at the position z₂). For example, the coordinate position of the light-transmissive hole in the reference image 810 (when the objective lens 122 is at the position z₂) may be obtained by determining moments of the origin of the image, obtaining the position of the center of the light spot by performing a Gaussian fitting on the image, and determining a position of a maximum value of a gray level of the image, and so on.

In some embodiments, for the i^{th} light source of the at least one light source 121-1 of the illumination device 121, for the p^{th} light-transmissive hole of the at least two light-transmissive holes 111-1, the coordinate position of the p^{th} light-transmissive hole in the projection image 820 corresponding to the i^{th} light source may be

$${x}_{i}^{p} = ( {x}_{i}^{p} , {y}_{i}^{p} , 0 ) ,$$

in which

$${x}_{i}^{p} , {y}_{i}^{p}$$

are horizontal coordinates of the of the p^{t} light-transmissive hole in the projected image 820 corresponding to the i^{th} light source, p=1, 2, . . . , N, N being the total count of light-transmissive holes. Since the focal point (when the objective lens is focused on the surface of the auxiliary imaging element toward the illumination device) on the focal plane is the origin of the z-axis, i.e., the projection image 820 is detected in the focal plane of the imaging system, the coordinate of the z-axis of the position of the p^{th} light-transmissive hole in the projection image 820 may be zero.

It should be noted that those skilled in the art may use other process(es) to obtain, in the projection image 820, the coordinate position of a projection point of the light passing through the light-transmissive hole (when the objective lens 122 is at the position z₁). For example, the coordinate position of the light-transmissive hole in the reference image 810 (when the objective lens 122 is at the position z₁) may be obtained by determining the moments of the origin of the image, obtaining the position of the center of the light spot by performing a Gaussian fitting on the image, and determining a position of a maximum value of a gray level of the image.

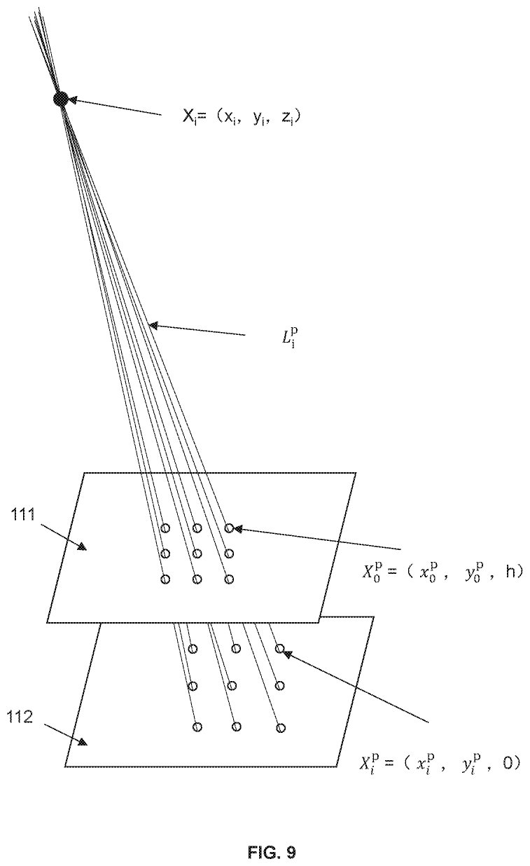

The intersection position may correspond to a position of the light source described above. In some embodiments, for each hole of the at least two light-transmissive holes, the processor may determine a straight line based on the first position of the each hole in the reference image and the second position of the each hole in the projection image corresponding to the each light source. For example, as shown in FIG. 9, for the i^{th} light source of the 225 light sources 121-1 of the illumination device 121, for the p^{th} light-transmissive hole of the 9 light-transmissive holes 111-1, the coordinate position of the p^{th} light-transmissive hole in the reference image 810 is

$${x}_{o}^{p} = ( {x}_{o}^{p} , {y}_{o}^{p} , h ) ,$$

and the coordinate position of the p^{th} light-transmissive hole in the projection image 820 corresponding to the i^{th} light source is

$${x}_{i}^{p} = ( {x}_{i}^{p} , {y}_{i}^{p} , 0 ) ,$$

and the processor may determine 9 straight lines

$${L}_{i}^{p}$$

that pass through both

$${x}_{o}^{p} = ( {x}_{o}^{p} , {y}_{0}^{p} , h ) and {x}_{i}^{p} = ( {x}_{i}^{p} , {y}_{i}^{p} , 0 ) .$$

Further, the processor may determine an intersection point (e.g., xᵢ=(xᵢ,yᵢ,zᵢ)) of the 9 straight lines

$${L}_{i}^{p}$$

based on the 9 straight lines corresponding to the 9 light-transmissive holes through, e.g., a least squares method illustrated in Equation (1):

$${min}_{{x}_{i}} {\sum }_{p = 1}^{9} {d}^{2} ( {x}_{i} , {L}_{i}^{p} ) , d ( {x}_{i} , {L}_{i}^{p} ) = ‖ {x}_{i} - {L}_{i}^{p} ‖ , \qquad ( 1 )$$

where

$${L}_{i}^{p}$$

is a straight line formed by the light emitted by the i^{th} light source through the p^{th} light-transmissive hole, and

$$d ( {x}_{i} , {L}_{i}^{p} )$$

denotes the distance between a position of the i^{th} light source xᵢ=(xᵢ,yᵢ,zᵢ) and the straight line

$${L}_{i}^{p} .$$

It should be noted that the intersection position xᵢ=(xᵢ,yᵢ,zᵢ) may be obtained using other algorithm(s) such as matrix solving for pseudo-inverse, solving systems of linear equations, gradient descent algorithm, iterative optimization algorithm, etc., in addition to the least squares solution provided in the above embodiment.

The preset relationship refers to a relationship between a position of the light source (i.e., the intersection position) and the illumination angle data of the light source. For example, the preset relationship may be described in Equation (2) below.

In some embodiments, the processor may determine the illumination angle data ki of the light source corresponding to the intersection based on the intersection xᵢ=(xᵢ,yᵢ,zᵢ) and Equation (2):

$${k}_{i} = \frac{( {x}_{i} , {y}_{i} , {z}_{i} )}{\sqrt{{x}_{i}^{2} + {y}_{i}^{2} + {z}_{i}^{2}}} {k}_{0} , \qquad ( 2 )$$

where

$${k}_{0} = \frac{2 π}{λ}$$

is an illumination wave vector in vacuum and A is a wavelength of the illumination light.

FIG. 10 is a schematic diagram illustrating comparison results of illumination angles of LEDs between with and without calibration according to some embodiments of the present disclosure. As shown in FIG. 10, gray points represent the results of the illumination angle data after calibration, and black points are the results of the illumination angle data (in which an even distribution of the LED bead positions may be assumed) without calibration. From the comparison results in FIG. 10, it may be seen that without calibration, the positions of the LED beads are assumed to be even distributed, while the positions of the LED beads are uneven distributed after calibration, and the calibrated positions of the LED beads are more accurate.

It should be appreciated that the count of light-transmissive holes is at least two, since two straight lines may determine an intersection, and each light-transmissive hole corresponds to a straight line. If the count of light-transmissive holes is two, the intersection of the two straight lines may be directly determined as an intersection. If the count of the light-transmissive holes is greater than or equal to three, the intersection may be determined using an approach such as the least squares solution. The count of equations for determining the illumination angle data by the least squares solution may relate to the count of light-transmissive holes, and the count of the light-transmissive holes in principle should be greater than or equal to 3. For example, as shown in FIG. 9, the count of light-transmissive holes in an array arrangement may be 3×3 (i.e., 9). It may be understood that the greater the count of light-transmissive holes, the greater the fitting accuracy and the more accurate the intersection position is determined.

In some embodiments, the sizes of the light-transmissive holes may or be the same or different. For example, the sizes of the light-transmissive holes may be the same, as shown in FIGS. 11A and 11B. As another example, the sizes of the light-transmissive holes may be different, as shown in FIGS. 11C and 11D. It should be understood that whether the sizes of the light-transmissive holes are the same or not does not affect the correction of the illumination angle data, but the size of the light-transmissive holes may affect the correction of the illumination angle data. If the light-transmissive hole is too large, a linearity of the light passing through the light-transmissive hole may be affected, thereby affecting the accuracy of the determined intersection, which in turn affects the accuracy of the determined illumination angle data. If the light-transmissive hole is too small, a diffraction effect and a diffraction ring may be generated, which in turn affects the accuracy of the determined illumination angle data, and a hole that is too small may reduce the amount of light passing through the hole, decreasing the brightness of the image.

In some embodiments, the distances or intervals between the light-transmissive holes may be even or uneven. The intervals of the light-transmissive holes refer to the distances between the centers (e.g., geometric centers) of the light-transmissive holes. For example, as shown in FIGS. 11A and 11C, the distance between the light-transmissive holes may be the same. For another example, as shown in FIGS. 11B and 11D, the distances between the light-transmissive holes may be different. It should be appreciated that whether the distances between the light-transmissive holes are even or not does not affect the correction of the illumination angle data, and an arrangement of the light-transmissive holes does not affect the correction of the illumination angle data. The interval arrangement of the light-transmissive holes needs to satisfy: for the at least one light source of the illumination device, the various positions of the light-transmissive holes in the projection image corresponding to the at least one light source need to be located in an field of view of the imaging system, and the range in which the positions are located needs to be larger than a preset percentage of the entire field of view of the imaging system, to avoid that the positions described above are concentrated in a small area in the field of view of the imaging system, thereby making the results more accurate. The preset percentage may be set artificially, for example, the preset percentage may be 50%, 60%, 65%, or the like. The range in which the positions are located is the smallest range in the field of view of the imaging system that can cover the positions. The field of view refers to a range observed by the microscope.

In some embodiments of the present disclosure, the present calibration method of the present disclosure achieves the calibration of the illumination angle data without relying on the at least one light source that is arranged in matrix or other regular arrangement. In addition, the method for calibration of the present disclosure is independent of the target object and achieves an alignment of the illumination angle data prior to image reconstruction without affecting an reconstruction iteration process and without the need to calibrate the illumination angle data through complex algorithms during each image reconstruction of the target object. In addition, the calibration method of the present disclosure is not mutually exclusive with other online calibration methods, and may provide more accurate initial illumination angles for currently available online calibration schemes.

It should be noted that the foregoing descriptions of a process of the calibration of the microscope illumination angle are merely provided for the purpose of illustration and are not intended to limit the scope of the present disclosure. For those skilled in the art, various amendments and variations may be made to the microscope illumination angle calibration process under the guidance of the present disclosure. However, these amendments and variations remain within the scope of the present disclosure. In some embodiments, operations 510, 530, 520, and 540 may be performed sequentially.

In some embodiments, the system for calibrating the illumination angle of the microscope may include: a phantom including a plurality of light-transmissive holes, the phantom being configured to obtain the reference image by imaging the plurality of light-transmissive holes using the microscope; an auxiliary imaging element configured to obtain at least one projection image corresponding to at least one light source of an illumination device of the microscope. The at least one projection image may be obtained by: starting the at least one light source of the illumination device to emit light one by one, when any light source of the at least one light source is started to emit light, imaging a projection of the light that is emitted by the any light source and passes through the plurality of light-transmissive holes on the auxiliary imaging element, and obtaining a projection image corresponding to the any light source. The system for calibrating the illumination angle of the microscope may further include a processor configured to determine illumination angle data of the microscope based on the reference image and the at least one projection image.

The beneficial effects provided by the embodiments of the present disclosure may include, but not limited to: (1) by imaging the calibration device using the microscope, the initial image is obtained, the illumination angle data of the microscope is further determined, the high-quality image reconstruction result is obtained by calibrating the target image of the target object; (2) the calibration method of the present disclosure achieves the calibration of the illumination angle data relying on the at least one light source that is arranged in a matrix or other regular arrangement; (3) the calibration method of the present disclosure is independent of the target object and achieves the alignment of the illumination angle data before reconstruction without affecting the reconstruction iteration process, and eliminates the need to calibrate the illumination angle data through the complex algorithm during each image reconstruction; (4) the calibration method of the present disclosure is not mutually exclusive with other online calibration methods, and may provide more accurate initial illumination angles for currently available online calibration schemes; (5) when the illumination angle data is determined, the processor can store the illumination angle data in a storage device. After imaging the target object subsequently, the processor may directly obtain the illumination angle data and perform the calibration and reconstruction without repeatedly using the calibration device for calibration, thereby improving the efficiency.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms one embodiment, an embodiment, and/or some embodiments mean that a particular feature, structure, or characteristic described in connection with the embodiment is included in at least one embodiment of the present disclosure. Therefore, it is emphasized and should be appreciated that two or more references to an embodiment or one embodiment or an alternative embodiment in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term about, approximate, or substantially. For example, about, approximate, or substantially may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Therefore, by way of example, but not of limitation, alternative configurations of the embodiments of the application may be utilized in accordance with the teachings herein. Accordingly, embodiments of the present application are not limited to that precisely as shown and described.

What is claimed is:

1. A method for calibrating an illumination angle of a microscope, comprising:
obtaining one or more initial images by imaging a calibration device using the microscope; and
determining illumination angle data of the microscope based on the one or more initial images.

2. The method of claim 1, wherein the calibration device includes a phantom, and the phantom includes at least two light-transmissive holes.

3. The method of claim 2, wherein the calibration device further includes an auxiliary imaging element.

4. The method of claim 3, wherein the obtaining one or more initial images by imaging the calibration device using the microscope includes:
obtaining a reference image by imaging the at least two light-transmissive holes using the microscope; and
starting at least one light source of an illumination device of the microscope to emit light one by one, when any light source of the at least one light source is started to emit light,
imaging a projection of the light that is emitted by the any light source and passes through the at least two light-transmissive holes on the auxiliary imaging element, and
obtaining a projection image corresponding to the any light source.

5. The method of claim 4, wherein determining illumination angle data of the microscope based on the one or more initial images includes:
determining the illumination angle data based on first positions of the at least two light-transmissive holes in the reference image and second positions of the at least two light-transmissive holes in at least one projection image corresponding to the at least one light source.

6. The method of claim 5, wherein the determining the illumination angle data based on first positions of the at least two light-transmissive holes in the reference image and second positions of the at least two light-transmissive holes in at least one projection image corresponding to the at least one light source includes:
for each light source of the at least one light source of the illumination device,
for each hole of the at least two light-transmissive holes, determining a straight line based on a first position of the each hole in the reference image and a second position of the each hole in a projection image corresponding to the each light source;
determining an intersection position of at least two straight lines based on at least two straight lines corresponding to the at least two light-transmissive holes; and
determining the illumination angle data corresponding to the each light source based on the intersection position and a preset relationship.

7. The method of claim 4, wherein the starting at least one light source of an illumination device of the microscope to emit light one by one includes:
placing an objective lens of the microscope at a first working position, and
starting the at least one light source of the illumination device of the microscope to emit light one by one.

8. The method of claim 7, wherein the obtaining a reference image by imaging the at least two light-transmissive holes using the microscope includes:
placing the objective lens at a second working position, and
obtaining the reference image by imaging the at least two light-transmissive holes using the microscope.

9. The method of claim 8, wherein a distance between the first working position and the second working position is related to a distance between the phantom and the auxiliary imaging element.

10. The method of claim 7, further comprising:
determining the first working position, including:
placing the auxiliary imaging element on a sample observation stage of the microscope, focusing the objective lens on a surface of the auxiliary imaging element facing the illumination device, and
designating a position of the objective lens as the first working position.

11. The method of claim 1, further comprising:
obtaining a target image by imaging a target object using the microscope; and
calibrating the target image based on the illumination angle data.

12. The method of claim 3, wherein
the obtaining one or more initial images by imaging a calibration device using the microscope includes:
placing an objective lens of the microscope at a first working position;
starting at least one light source of an illumination device of the microscope to emit light one by one, when any light source of the at least one light source is started to emit light,
imaging a projection of the light that is emitted by the any light source and passes through the phantom on the auxiliary imaging element, and
obtaining a projection image corresponding to the any light source;
placing the objective lens at a second working position;
obtaining a reference image by imaging the phantom using the microscope, the one or more initial images including at least one projection image corresponding to the at least one light source and the reference image; and
the determining illumination angle data of the microscope based on the one or more initial images includes:
determining illumination angle data of the microscope based on the reference image and the at least one projection image corresponding to the at least one light source.

13. The method of claim 2, wherein a count of the at least two light-transmissive holes is 9.

14. The method of claim 2, wherein sizes of the at least two light-transmissive holes are different.

15. The method of claim 2, wherein sizes of the at least two light-transmissive holes are the same.

16. The method of claim 2, wherein distances between the at least two light-transmissive holes are uneven.

17. The method of claim 2, wherein distances between the at least two light-transmissive holes are even.

18. The method of claim 2, wherein the phantom is made of a light-impermeable material.

19. The method of claim 3, wherein the auxiliary imaging element is a glass sheet made of an optical scattering material.

20. A system for calibrating an illumination angle of a microscope, comprising:
an initial image obtaining module, configured to obtain one or more initial images by imaging a calibration device using the microscope; and
an illumination angle data determination module, configured to determine illumination angle data of the microscope based on the one or more initial images.
